(19) United States
(12) Patent Application Publication
(10) Pub. No.: US 2011/0294423 A1
(43) Pub. Date: Dec. 1, 2011

(54) DUAL-MODE EARPHONE AND METHOD FOR ANSWERING USING THE SAME

(76) Inventor: PI-FEN LIN, KEELUNG CITY (TW)

(21) Appl. No.: 12/786,934

(22) Filed: May 25, 2010

(51) Int. Cl. H04W 88/02; H04B 7/00; H04M 1/00

(52) U.S. Cl. 455/41.2; 455/569.1; 379/420.04

(57) ABSTRACT

Provided is an earphone with dual communication modes and a method for answering using the same. The earphone wirelessly links a first remote device and a second remote device. The earphone particularly includes a microprocessor coupled with a Bluetooth communication module, a DECT communication module, a microphone, and a speaker. The microprocessor is controlled by a first control signal, and used for transmitting a first incoming signal or a second incoming signal to the speaker. The microprocessor then sends a reply signal to the first remote device via the Bluetooth communication module, or to the second remote device via the DECT communication module. The first incoming signal is outputted as the first remote device receives an incoming call, and the second incoming signal is outputted when the second remote device receives the incoming call. Finally, the microphone outputs the reply signal.

### BACKGROUND OF THE INVENTION

1. Field of the Invention

The present invention relates to an earphone with dual communication modes and a related method for answering, in particular, the earphone is functioned with dual communication mode, and capable of answering incoming call by a dual-mode module.

2. Description of Related Art

The current widespread methods of communication are using cellular phone and regular phone through PSTN. These two methods operate independently. So that, the user may not answer a PSTN phone call simultaneously while he is taking a cellular phone call. Similarly, the user may not answer the cellular phone call when he is answering the PSTN incoming call.

Reference is made to FIG. 1, which schematically shows an outward appearance of the traditional wireless phone set. This wireless phone set 1 is primarily applied to PSTN communication, and composed of a wireless dial-up phone 12 and a communication base 14. A technology of digital enhanced cordless telecommunication (DECT) is often used for wirelessly linking the wireless dial-up phone 12 and the communication base 14. The communication base 14 is preferably connected to PSTN 16. Thus, the user may use the wireless dial-up phone 12 to process PSTN phone call.

However, since the wireless dial-up phone 12 is functioned with wireless communication, the user may not use it for long time for the user may have pain in his hand.

Referring to FIG. 2, a structure of the conventional Bluetooth earphone linked with the Bluetooth cell phone is shown. The Bluetooth communication technology is applied to the set with the Bluetooth cell phone 20 and the earphone 22. The incoming voice message 24 of the Bluetooth cell phone 20 is transferred to the Bluetooth earphone 22 by means of wireless communication. The voice message 26 is transferred to the phone 20 via the Bluetooth earphone 22 by applying the Bluetooth communication technology. Ae bi-directional voice communication is also available. A handsfree earphone may make the user answer a phone call everywhere.

Although the handsfree earphone may be benefited by the Bluetooth communication technology, only the Bluetooth cell phone 20 performs the bi-directional communication instead of PSTN phoning. That is, the user may not answer the traditional PSTN call using the Bluetooth earphone 22. The PSTN call may be lost at the moment as the user uses the Bluetooth earphone 22 to answer a previous call.

### SUMMARY OF THE INVENTION

In view of the conventional drawback, provided is a dual-mode earphone in accordance with the present invention. The claimed dual-mode earphone is capable of monitoring both incoming call from one Bluetooth device and one call from PSTN phone. Particularly, in the present invention, a Bluetooth communication and a DECT communication are used for processing a bi-directional communication or a three-way call.

In accordance with one embodiment of the present invention, the dual-mode earphone wirelessly communicates with a first remote device and a second remote device. In the dual-mode earphone, a first communication module, a second communication module, a microphone, a speaker and a microprocessor are included. The first communication module is preferably used for communicating with the first remote device, and outputting a first incoming signal when the first remote device receives an incoming call. The second communication module is used for wirelessly communicated with the second remote device, and outputting a second incoming signal when the second remote device receives the incoming call. The microphone the outputs a reply signal.

The microprocessor is coupled with the first communication module, the second communication module, the microphone and speaker. The microprocessor is controlled by a first control signal and used for transmitting the first incoming signal or the second incoming signal to the speaker. Further the microprocessor transmits the reply signal through the first communication module to the first remote device. Alternatively, the reply signal is transmitted to the second remote device through the second communication module.

Furthermore, the microprocessor is controlled by a second control signal, and is used to transmit the first incoming signal and the second incoming signal to the speaker simultaneously. At the same time, the reply signal is transmitted to the first remote device and second remote device via the first communication module and the second communication module.

Consequently, a user can only use the claimed dual-mode earphone to apply to two different network systems. In one embodiment, it is featured that an incoming call from one of the network systems selected to be answered so as to process a two-way call. Alternatively, the claimed earphone may simultaneously answer the incoming calls over two different network systems. In particular, the dual-mode earphone can be a channel for bridging the two network systems in order to process a three-way communication. Thus the dual-mode earphone in accordance with the present invention provides a more convenient way to answer an indoor call without losing call.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 schematically shows an appearance of a traditional wireless phone set;

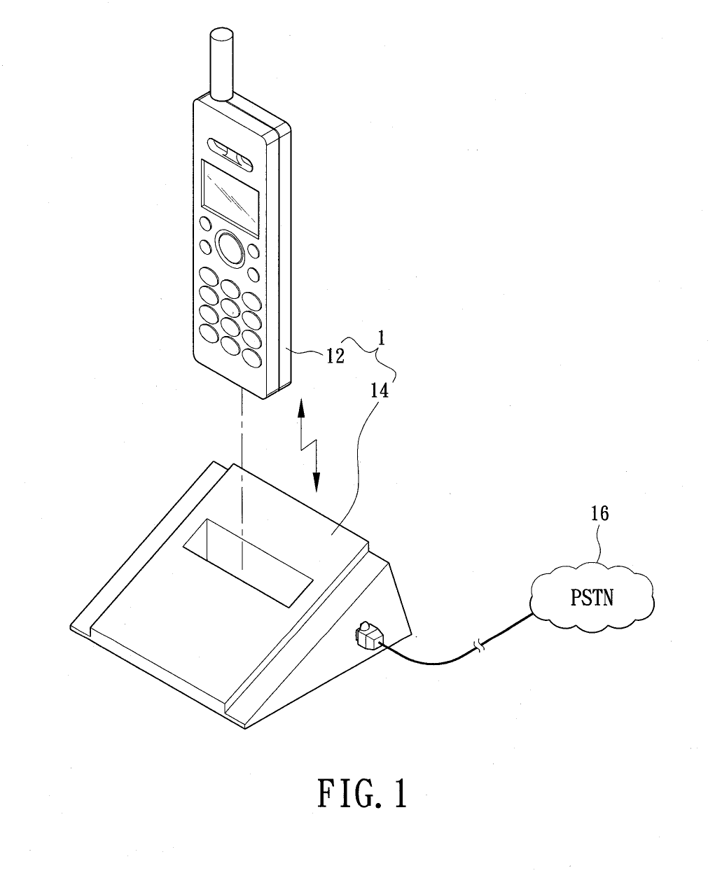

FIG. 2 shown a schematic diagram of the communication between the traditional Bluetooth earphone and the cellular phone;

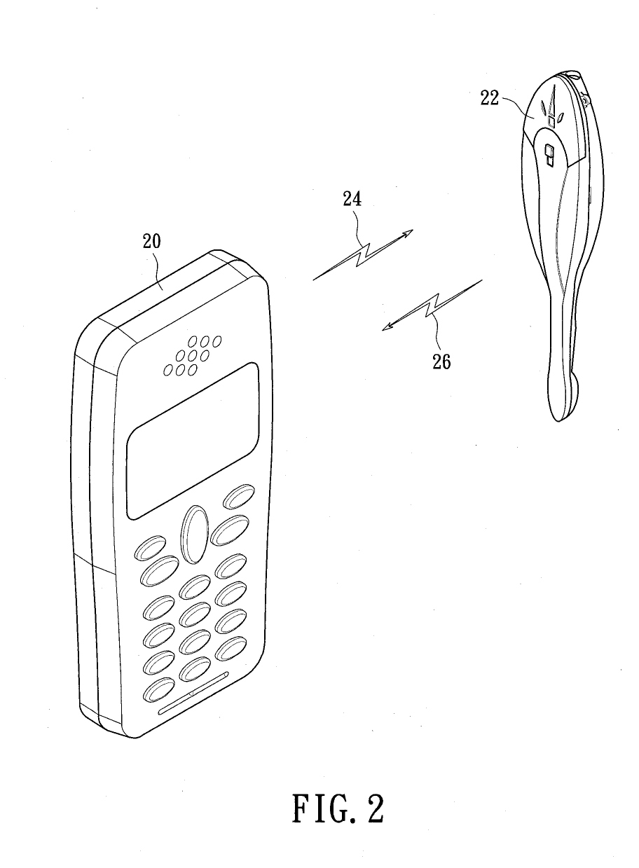

FIG. 3A is a schematic diagram of the environment used by the earphone of the present invention;

FIG. 3B shows a schematic diagram of the latch mechanism employed in the present invention;

FIG. 4 shows a block diagram of the dual-mode earphone in accordance with the present invention;

FIG. 5 is an exemplary example using the claimed earphone; and

FIG. 6 is a flow chart of illustrating the way to answer an incoming call using the claimed dual-mode earphone.

### DETAILED DESCRIPTION OF THE PREFERRED EMBODIMENTS

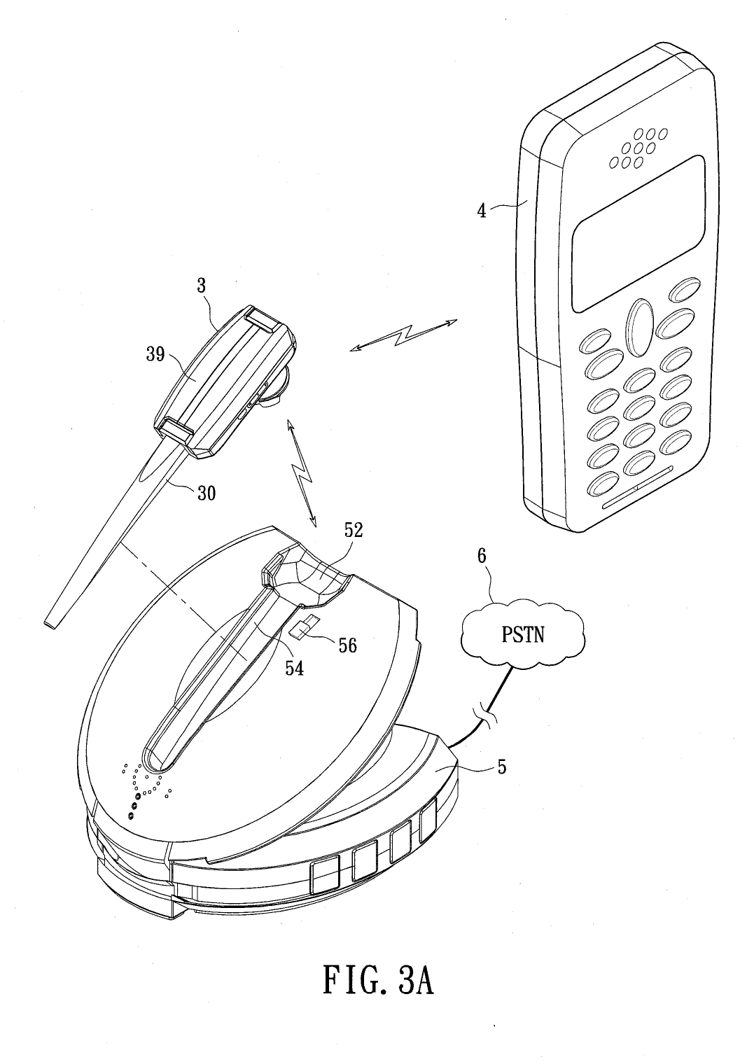

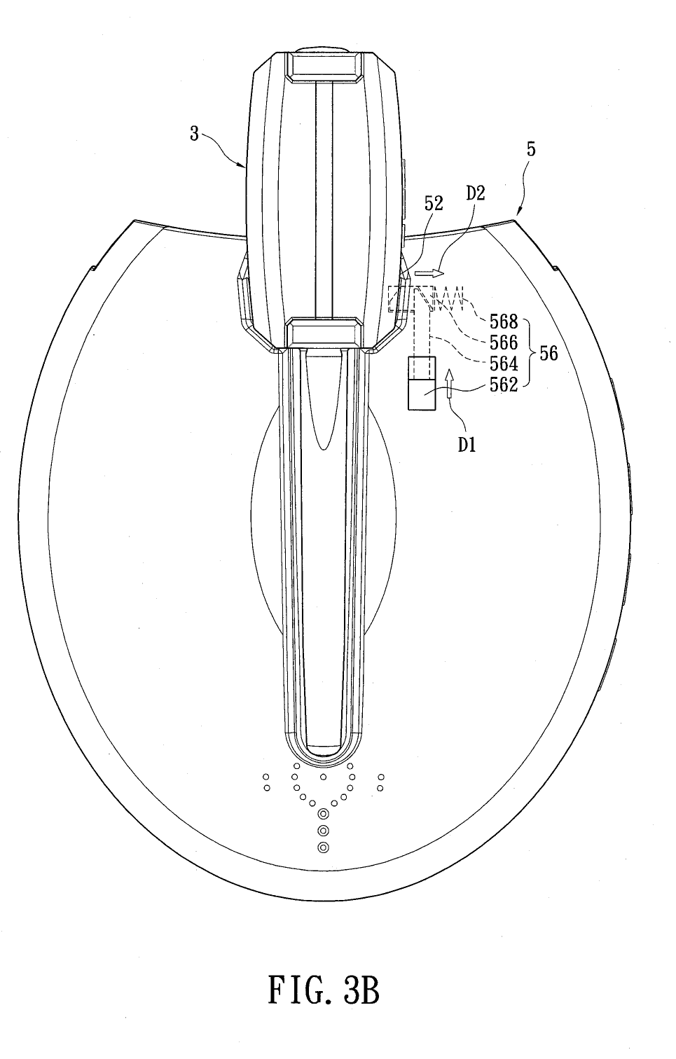

Refer to FIG. 3A showing a schematic diagram of the environment where the invention is applied to. According to one embodiment of the present invention, the dual-mode earphone 3 is provided to process a Bluetooth wireless communication with a first remote device 4, and also a DECT wireless communication with a second remote device 5. In particular, the first remote device 4 can be a Bluetooth handheld device, such as a Bluetooth cell phone, Bluetooth PDA, Bluetooth handheld computer, and the like. On the other hand, the second remote device 5 can be a PSTN phone base that is linked to PSTN 6.

Reference is made to FIG. 3A. An earphone slot 52 is particularly disposed upon the second remote device 5. In the earphone slot 52, a magnetic component 54, such as a magnet, is disposed. The dual-mode earphone 3 in accordance with the present invention can be separably disposed into the earphone slot 52. When the earphone 3 is placed into the earphone slot 52, the earphone 3 is electrically connected to the second remote device 5. On the contrary, when the earphone 3 is separated from the earphone slot 52, this dual-mode earphone 3 not only can be communicated with the second remote device 5 by means of the technology of digital enhanced cordless telecommunication (DECT), but also communicated with the first remote device 4 by Bluetooth wireless communication.

The FIG. 3A further shows a magnetic-permeable component 30 is disposed on an earphone shell 39 of the claimed dual-mode earphone 3. This magnetic-permeable component 30 corresponds to a magnetic component 54 of the second remote device 5. When the dual-mode earphone 3 approaches the earphone slot 52, the magnetic component 54 in the earphone slot 52 will attracts the magnetic-permeable component 30 of the earphone 3. Therefore, the dual-mode earphone 3 can be inserted into the slot 52 quickly. The magnetic-permeable component 30 is preferably made of metal or any magnetically-attractable component.

The design using the magnetic material is benefited by the magnetic component 54 in the earphone slot 52. The magnetic-permeable component 30 of the earphone 3 is attracted by the component 54 as the dual-mode earphone 3 approaches the earphone slot 52 of the second remote device 5. Therefore, it is featured that the dual-mode earphone 3 can be quickly inserted into the earphone slot 52, and electrically connected to the second remote device 5.

FIG. 3A further shows the dual-mode earphone 3 being disposed on the second remote device 5. The metal-made contacts are used for electrically connecting the dual-mode earphone 3 and the second remote device 5. Furthermore, it is provided with a latch mechanism 56 in the second remote device 5 for optionally latching the earphone 3 in the slot 52, so as to prevent the children from being taken.

In view of the illustration regarding FIG. 3A, reference is made to FIG. 3B. In which, a schematic diagram of the latch mechanism is shown. The latch mechanism 56 includes a driving member 562, a connection member 564, a lock member 566, and a restore member 568. As the driving member 562 is enabled as moving toward the direction D1, the driving member 562 may drive the lock member 566 to move to the direction D2 through the connection member 564. The dual-mode earphone 3 may then be released from the latched in the earphone slot 52. On the other hand, when the driving member 562 is enabled downward. The restore member 568 may further push the lock member 566 to move leftward. In the meantime, the dual-mode earphone 3 can be latched into the earphone slot 52.

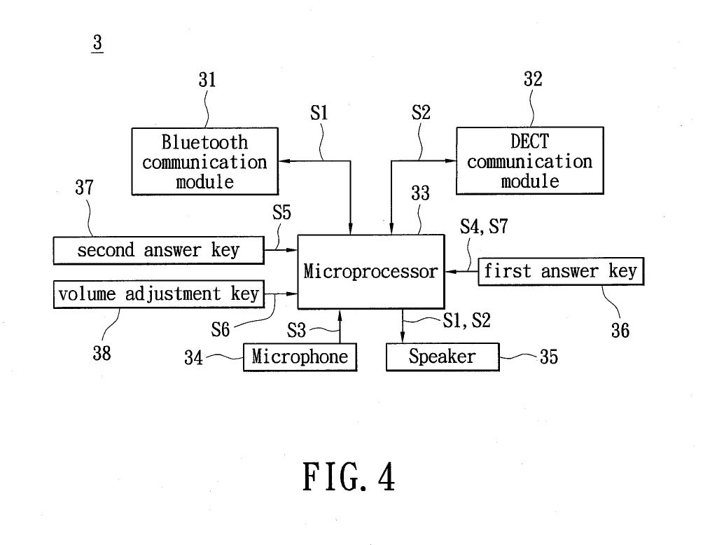

Reference is made to FIG. 4 in further view of FIG. 3A. FIG. 4 shows a block diagram of the dual-mode earphone in accordance with the present invention. The dual-mode earphone 3 particularly includes a Bluetooth communication module 31, a DECT module 32, a microprocessor 33, a microphone 34, a speaker 35, a first answer key 36, a second answer key 37, and a volume adjustment key 38.

The microprocessor 33 is coupled to the Bluetooth communication module 31, the DECT module 32, the microphone 34, the speaker 35, the first answer key 36, the second answer key 37, and the volume adjustment key 38. The microprocessor 33 serves as a central processor communicating the every elements in the earphone.

The Bluetooth communication module 31 is used for communicating with the first remote device 4 wirelessly. A first incoming signal S1 is outputted when the first remote device 4 receives an incoming call. The DECT module 32 is used for wirelessly communicating with the second remote device 5. The DECT module 32 outputs a second incoming signal S2 when the second remote device 5 receives an incoming call. The microphone 34 then outputs replay signal S3 as answering.

While one of the first remote device 4 and the second remote device 5 receives the incoming call, the first answer key 36 may be used to generate a first control signal S4. In the meantime, the microprocessor 33 is controlled by this first control signal S4, and used to transmit the corresponding first incoming signal S1 or the second incoming signal S2 to the speaker 35. More, the microprocessor 33 may be simultaneously receives the signal S3 from the microphone 34 and transmits the signal S3 to the first remote device 4 through the Bluetooth communication module 31, or alternatively, transmits the reply signal S3 to the second remote device 5 through the DECT module 32. No matter the first remote device 4 or the second remote device 5 receives the incoming cal, the dual-mode earphone 3, according to the present invention, may be used for processing the communication on the incoming call received by the first remote device 4 or by the second remote device 5 by handheld means. Therefore, a bi-directional communication with a remote user is carried out.

In FIG. 4, during the period of the dual-mode earphone 3 linked with the first remote device 4 for wireless communication, the user may press the second answer key 37 to output a second control signal S5 if the second remote device 5 receives an insertion call. The microprocessor 33 is controlled by the second control signal S5, and used for transmitting both the first incoming signal S1 and the second incoming signal S2 to the speaker 35. Furthermore, the reply signal S3 can be transmitted to the corresponding first remote device 4 and second remote device 5 via respective Bluetooth communication module 31 and DECT module 32.

Meanwhile, the microprocessor 33 is also controlled by the second control signal S5, and used to transmit the first incoming signal S1 to the second remote device through the DECT module 32. Further, the second incoming signal S2 is transmitted to the first remote device 4 through the Bluetooth communication module 31. The microprocessor 33 serves as a bridge between the first remote device 4 and the second remote device 5. The user may use the claimed dual-mode earphone 3 links to the first remote device 4 and the second remote device 5 simultaneously for wireless communication by handheld means when any incoming call is received. The first remote device 4 may also be vocally communicated with the second remote device 5 via the dual-mode earphone 3. Thus a three-way communication is carried out.

In addition to the microprocessor 33 being respectively controlled by the first control signal S4 and the second control signal S5, the microprocessor 33 may be controlled by a volume control signal S6 outputted from the volume adjustment key. The microprocessor 33 may adjust the output volume from the speaker 35 according to the volume control signal S6. And further, the microprocessor 33 may receive a hang-up signal S7, and accordingly hang up the call. In which the hang-up signal S7 is preferably generated by the abovementioned first answer key 36. In accordance with one of the embodiments, when first click is pressed on the first answer key 36, the first answer key 36 generates the first control signal S4, so as to control the answering function made by the microprocessor 33. If a next click is then pressed on the first answer key 36, the first answer key 36 may generate the hang-up signal S7 for hanging up the call. Furthermore, if the first answer key 36 is continuously pressed for a while, for example 5 seconds, the claimed dual-mode earphone 3 may be shutdown.

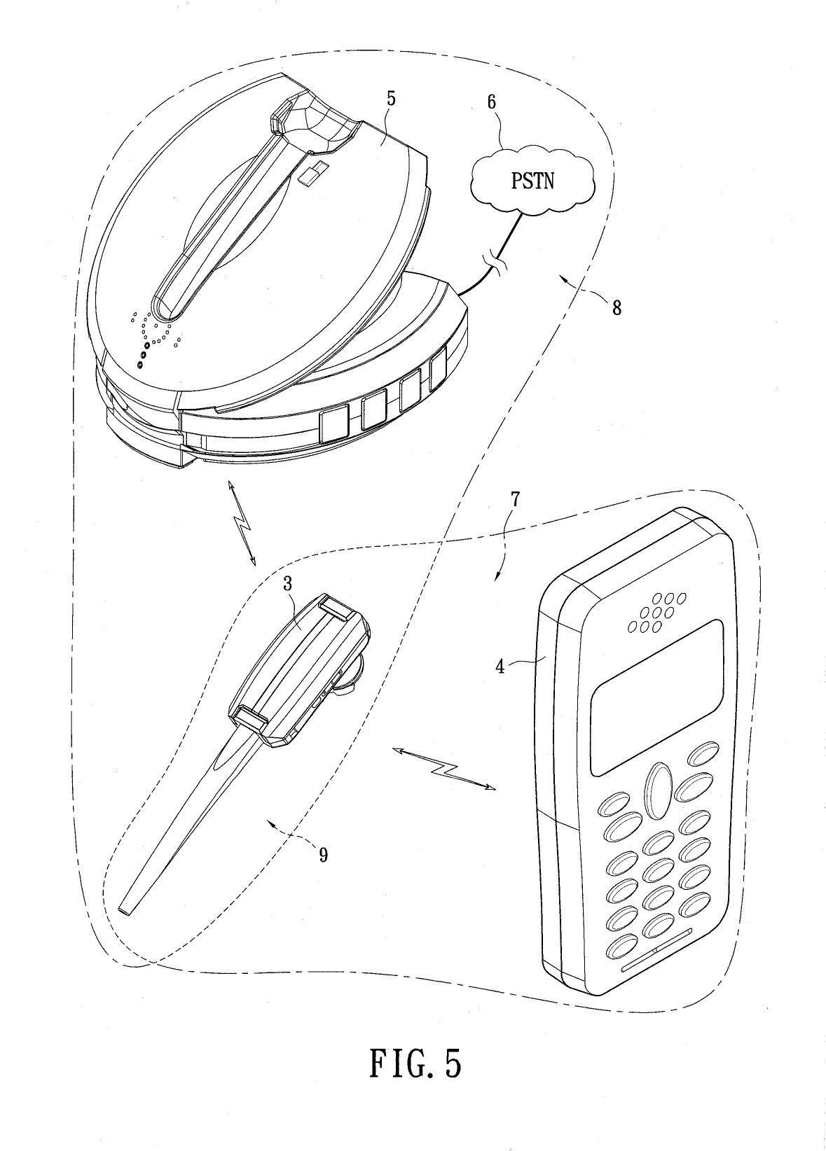

Reference is made to FIG. 5, which schematically illustrates an exemplary manipulation of the dual-mode earphone in accordance with the present invention. The dual-mode earphone 3 is interconnected with the first remote device 4 over a Bluetooth communication network 7. When the dual-mode earphone 3 is within a broadcast range of the Bluetooth communication network 7, it may perform a wireless vocal communication with the first remote device 4. Still further, the dual-mode earphone 3 may be coupled with the second remote device 5 over PSTN 6 using a DECT communication module 8. When the earphone 3 is located within the signaling range of DECT communication module 8, a vocal communication may be performed with the second remote device 5.

Refer to FIG. 5 again. When the dual-mode earphone 3 is located in an overlapped network 9 within the range of both the Bluetooth communication network 7 and the DECT communication module 8. The dual-mode earphone 3 may separately communicate with the first remote device 4 or the second remote device 5 in order to process a two-way communication. Or alternatively, a three-way communication can be processed by simultaneously linking with the first remote device 4 and the second remote device 5.

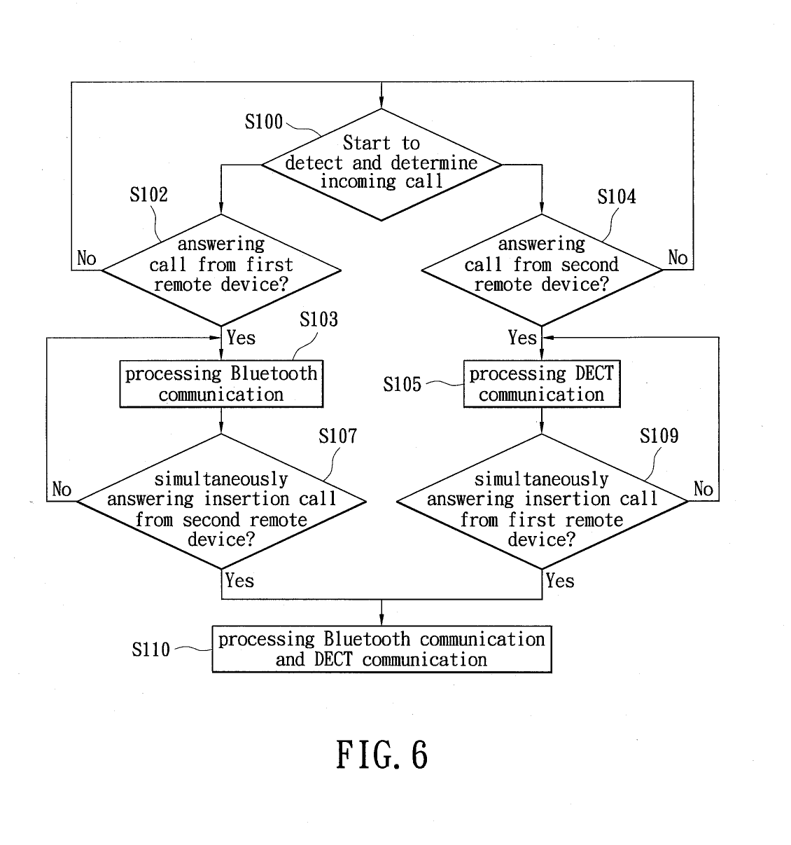

Reference is made to FIG. 6 in view of both FIG. 4 and FIG. 5. FIG. 6 shows a flow chart of illustrating an incoming call being answered by the dual-mode earphone. In the current embodiment, the dual-mode earphone 3 is within the overlapped network 9 over the range of both the Bluetooth communication network 7 and the DECT communication module 8. Meanwhile, the dual-mode earphone 3 utilizes both the first communication module and the second communication module to monitor any incoming call. Therefore, any incoming call received by the first remote device 4 or the second remote device 5 can be detected (step S100). In an exemplary example, the first communication module is preferably a Bluetooth communication module 31, and the second communication module is a DECT communication module 32. Alternatively, the first communication module is implemented by the DECT communication module 32, and the second communication module is Bluetooth communication module 31.

When the first communication module of the dual-mode earphone 3 detects an incoming call from the first remote device 4, it is then determined that whether the incoming call is received (step S102). If the incoming call is not received, it means “no” and goes back to step S100 for further detection. However, if the incoming call is received, it means that the first communication module has been communicated with handshake process with the first remote device 4 over Bluetooth communication. Then it successfully performs a bi-directional communication with the remote end. In the meantime, the second communication module may still detect any incoming call from others (step S103).

Furthermore, when the second communication module has detected an insertion signal from the second remote device 5, the step S107 in the method is to determine whether or not the insertion signal is answered. If the insertion signal is not answered, the step goes back to step S103 and continuously performs detection. Otherwise, if the insertion signal is answered after the step S107, it means “yes”. Along with the first communication module, the first remote device 4 is linked using the Bluetooth communication, the second communication module is simultaneously linked with the second remote device 5 by means of DECT communication. Therefore, a three-way communication is carried out (step S110).

Further reference is made to FIG. 6 in an exemplary example. When the second communication module of the dual-mode earphone 3 has detected the incoming call from the second remote device 5, the step in the method is to determine whether or not the incoming call is answered (step S104). If the incoming call is not answered, the step goes back to step S100 for further detection. If the incoming call is answered, it is determined that the second communication module and the second remote device 5 have been communicated with each other by means of DECT communication. A two-way communication is then performed. In the meantime, the first communication module of the earphone may still detect any incoming call from others (step S105).

In the occasion of the described first communication module detects an insertion signal from the first remote device 4, the step is then determined whether or not the insertion signal is answered (step S109). If the insertion signal is not answered, it means “no” and goes back to step S105 for further detection. However, if the insertion signal is answered, the first communication module will establish a communication with the first remote device 4 using Bluetooth communication. Meanwhile, the second communication module has established a DECT communication with the second remote device 5. After that, the three-way communication is carried out (step S110).

To sum up the above description, according to the present invention, any user may only use the claimed dual-mode earphone to process vocal communication over the two heterogeneous network environments. Once the earphone answers one incoming call from one of the networks, two-way communication is performed. Alternatively, two incoming calls may be simultaneously answered for performing three-way communication. The claimed dual-mode earphone brings very convenient way to process the phone call without lost.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A dual-mode earphone wirelessly connected with a first remote device and a second remote device, comprising:
a first communication module connected with the first remote device using a wireless connection, and outputting a first incoming signal when the first remote device receives a incoming call;
a second communication module wirelessly connected with the second remote device, and outputting a second incoming signal when the second remote device receives the incoming call;
a microphone used for outputting a reply signal;
a speaker;
a microprocessor coupled to the first communication module, the second communication module, the microphone, and the speaker, wherein the microprocessor is controlled by a first control signal, and used to transmit the first incoming signal or the second incoming signal to the speaker, and transmit the reply signal to the first remote device through the first communication module, or transmit the reply signal to the second remote device through the second communication module.

2. The dual-mode earphone of claim 1, wherein the microprocessor is controlled by a second control signal, and used to simultaneously transmit the first incoming signal and the second incoming signal to the speaker, and wirelessly transmit the reply signal to the first remote device and the second remote device through the first communication module and the second communication module; the microprocessor is further controlled by the second control signal, and used to wirelessly transmit the first incoming signal to the second remote device through the second communication module, and wirelessly transmit the second incoming signal to the first remote device through the first communication module.

3. The dual-mode earphone of claim 2, further comprising a first answer key which is coupled to the microprocessor, and used to output the first control signal or a hang-up signal to the microprocessor.

4. The dual-mode earphone of claim 3, further comprising a second answer key which is coupled to the microprocessor, and used to output the second control signal to the microprocessor.

5. The dual-mode earphone of claim 4, further comprising a volume adjustment key which is coupled to the microprocessor, and used to output a volume control signal to the microprocessor.

6. The dual-mode earphone of claim 1, wherein the first remote device is a kind of Bluetooth handheld device.

7. The dual-mode earphone of claim 6, wherein the second remote device is a PSTN phone base, and an earphone slot having a magnetic component is disposed in the PSTN phone base.

8. The dual-mode earphone of claim 7, wherein the dual-mode earphone is separably disposed in the earphone slot, and the dual-mode earphone includes an earphone shell with a magnetic-permeable component disposed opposite to the magnetic component.

9. The dual-mode earphone of claim 8, wherein the PSTN phone base has a latch mechanism used for locking the dual-mode earphone into the earphone slot.

10. The dual-mode earphone of claim 1, wherein the first communication module is a Bluetooth communication module, and the second communication module is a DECT communication module.

11. A method for answering an incoming call using a dual-mode earphone, comprising:
a. providing a first communication module and a second communication module detecting the incoming call;
b. an incoming call being detected by the first communication module;
c. determining whether or not answering the incoming call, if the incoming call is not answered, going on the detection;
d. if the incoming call is answered, using the first communication module to perform a bi-directional call, and the second communication module going on detecting further incoming call.

12. The method of claim 11, wherein after the step d, the method further comprising:
e. the second communication module detecting an insertion signal;
f. determining whether or not answering the insertion signal, if the insertion call is not answered, going on the detection;
g. if the insertion call is answered, both the first communication module and the second communication module are used to perform a three-way call.

13. The method of claim 12, wherein the first communication module is a Bluetooth communication module, and the second communication module is a DECT communication module; or the first communication module is the DECT communication module, and the second communication module is the Bluetooth communication module.
